(19) United States
(12) Patent Application Publication
(10) Pub. No.: US 2026/0208578 A1
(43) Pub. Date: Jul. 23, 2026

(54) GOLF CART WITH HYDRAULICALLY POWERED ACCESSORY IMPLEMENT

(71) Applicant: Textron Inc., Providence, RI (US)

(72) Inventors: Trevor Douglas Roebuck, Evans, GA (US); Ricky Veldee Kemp, Augusta, GA (US); Baily Guyton Wood, Dublin, GA (US)

(73) Assignee: Textron Inc., Providence, RI (US)

(21) Appl. No.: 19/035,467

(22) Filed: Jan. 23, 2025

(51) Int. Cl. B60K 17/28; B60K 17/02; B60L 7/24; B60T 1/06; B60T 13/14; F16H 57/04

(52) U.S. Cl. CPC B60K 17/28; B60K 17/02; B60L 7/24; B60T 1/062; B60T 13/148; F16H 57/045; B60L 2200/22; B60T 2260/00; B60T 2270/60

(57) ABSTRACT

A driveline for a golf cart includes a prime mover, tractive assemblies including tractive elements, an axle, and a gearbox. The tractive assemblies include tractive elements. The axle is coupled with the tractive elements. The gearbox is configured to transfer torque from the prime mover to the axle and the tractive elements to drive the tractive elements to transport the golf cart. The hydraulic system includes a hydraulic pump and a hydraulic implement interface. The hydraulic pump is fluidly coupled to a fluid reservoir. The hydraulic pump is configured to be driven by the prime mover. The hydraulic implement interface is fluidly coupled with the hydraulic pump and the fluid reservoir. The hydraulic implement interface is configured to engage with a hydraulic implement, receive a hydraulic fluid from the hydraulic pump, provide the hydraulic fluid to the hydraulic implement to operate, and return the hydraulic fluid to the fluid reservoir

### BACKGROUND

The present disclosure relates to a driveline for an electrified vehicle. More specifically, the present disclosure relates to braking and accessory drives for an electrified vehicle.

### SUMMARY

One embodiment relates to a golf cart. The golf cart includes a frame, a driveline, and a hydraulic system. The driveline is coupled with the frame. The driveline includes a prime mover, multiple tractive assemblies including tractive elements, an axle, and a gearbox. The tractive assemblies include tractive elements. The axle is coupled with the tractive elements. The gearbox is configured to transfer torque from the prime mover to the axle and the tractive elements to drive the tractive elements to transport the golf cart. The hydraulic system includes a hydraulic pump and a hydraulic implement interface. The hydraulic pump is fluidly coupled to a fluid reservoir. The hydraulic pump is configured to be driven by the prime mover. The hydraulic implement interface is fluidly coupled with the hydraulic pump and the fluid reservoir. The hydraulic implement interface is configured to engage with a hydraulic implement, receive a hydraulic fluid from the hydraulic pump, provide the hydraulic fluid to the hydraulic implement to operate, and return the hydraulic fluid to the fluid reservoir.

Another embodiment relates to a driveline for a golf cart. The driveline includes a prime mover, multiple tractive assemblies including tractive elements, an axle, and a gearbox. The tractive assemblies include tractive elements. The axle is coupled with the tractive elements. The gearbox is configured to transfer torque from the prime mover to the axle and the tractive elements to drive the tractive elements to transport the golf cart. The hydraulic system includes a hydraulic pump and a hydraulic implement interface. The hydraulic pump is fluidly coupled to a fluid reservoir. The hydraulic pump is configured to be driven by the prime mover. The hydraulic implement interface is fluidly coupled with the hydraulic pump and the fluid reservoir. The hydraulic implement interface is configured to engage with a hydraulic implement, receive a hydraulic fluid from the hydraulic pump, provide the hydraulic fluid to the hydraulic implement to operate, and return the hydraulic fluid to the fluid reservoir.

Still another embodiment relates to a recreational vehicle. The recreational vehicle includes a frame, a driveline, and a hydraulic system. The driveline is coupled with the frame. The driveline includes a prime mover, multiple tractive assemblies including tractive elements, an axle coupled with the tractive elements, a gearbox, a clutch, and a brake. The gearbox is configured to transfer torque from the prime mover to the axle and the tractive elements to drive the tractive elements to transport the recreational vehicle. The brake is configured to transition into an engaged state to limit movement of the gearbox, the axle, and the tractive elements. The hydraulic system includes a hydraulic pump, a hydraulic implement interface, and a pressure valve. The hydraulic pump is fluidly coupled to a fluid reservoir. The hydraulic pump is configured to be driven by the prime mover. The hydraulic implement interface is fluidly coupled with the hydraulic pump and the fluid reservoir. The hydraulic implement interface is configured to engage with a hydraulic implement, receive a hydraulic fluid from the hydraulic pump, provide the hydraulic fluid to the hydraulic implement to operate, and return the hydraulic fluid to the fluid reservoir. The pressure valve is operable to adjust hydraulic back-pressure experienced by the hydraulic pump to provide braking for the tractive elements through the prime mover, the gearbox, and the axle. The hydraulic pump is configured to simultaneously provide both braking for the tractive elements and pressurization of the hydraulic fluid to operate the hydraulic implement. The clutch is positioned either (a) between the prime mover and the gearbox to facilitate de-coupling the prime mover from the gearbox such that the prime mover can drive the hydraulic pump without driving the tractive elements, or (b) between the prime mover and the hydraulic pump to facilitate de-coupling the hydraulic pump from the prime mover such that the prime mover can drive the tractive elements to transport the recreational vehicle without driving the hydraulic pump.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a diagram of a driveline of the vehicle of FIG. 1 including an electronically controlled friction brake in a first position on the driveline, according to an exemplary embodiment.

FIG. 6 is a diagram of the driveline of the vehicle of FIG. 1 including the electronically controlled friction brake in a second position on the driveline, according to an exemplary embodiment.

FIG. 7 is a perspective view of the driveline of FIG. 6, according to an exemplary embodiment.

FIG. 8 is another perspective view of the driveline of FIG. 6, according to an exemplary embodiment.

FIG. 9 is a diagram of the driveline of the vehicle of FIG. 1 including a hydraulic pump configured to provide braking for the driveline using a housing of the gearbox as a fluid reservoir, according to an exemplary embodiment.

FIG. 10 is a diagram of the driveline of the vehicle of FIG. 1 including the hydraulic pump configured to provide braking for the driveline using a separate housing as the fluid reservoir, according to an exemplary embodiment.

FIG. 11 is a perspective view of the driveline of the vehicle of FIG. 1 including the hydraulic pump configured to provide braking for the driveline, according to an exemplary embodiment.

FIG. 12 is another perspective view of the driveline of FIG. 11, according to an exemplary embodiment.

FIG. 13 is another perspective view of the driveline of FIG. 11, according to an exemplary embodiment.

FIG. 14 is a block diagram of the driveline of the vehicle of FIG. 1 including a pair of clutches, an accessory drive, and a brake in a first position on the driveline, according to an exemplary embodiment.

FIG. 15 is a block diagram of the driveline of the vehicle of FIG. 1 including a pair of clutches, an accessory drive, and a brake in a first position on the driveline, according to an exemplary embodiment.

FIG. 16 is another block diagram of a portion of the driveline of FIG. 14 or FIG. 15, according to an exemplary embodiment.

FIG. 17 is a perspective view of the driveline of FIG. 14, according to an exemplary embodiment.

FIG. 18 is a top perspective view of the driveline of FIG. 14, according to an exemplary embodiment.

FIG. 19 is another top perspective view of the driveline of FIG. 14, according to an exemplary embodiment.

FIG. 20 is a top perspective view of a driveline of the vehicle of FIG. 1 including a hydraulic pump and external brakes, according to an exemplary embodiment.

FIG. 21 is a top view of the driveline of FIG. 20, according to an exemplary embodiment.

FIG. 22 is a rear view of the driveline of FIG. 20, according to an exemplary embodiment.

FIG. 23 is a perspective view of the driveline of FIG. 20 equipped with an interface for pressurized hydraulic fluid, according to an exemplary embodiment.

FIG. 24 is a top view of the driveline of FIG. 23, according to an exemplary embodiment.

FIG. 25 is a front perspective view of the driveline of FIG. 23, according to an exemplary embodiment.

FIG. 26 is a block diagram of a control system for the driveline of any of FIGS. 6-25, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

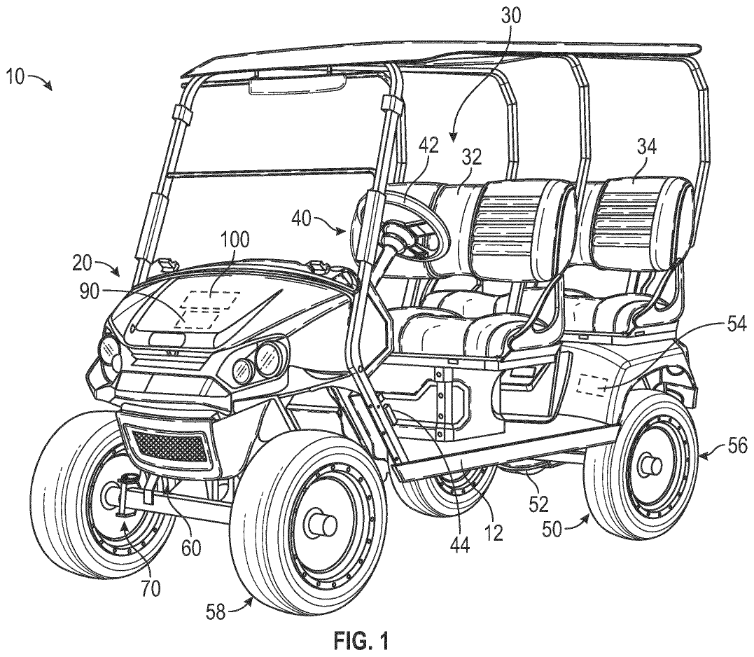

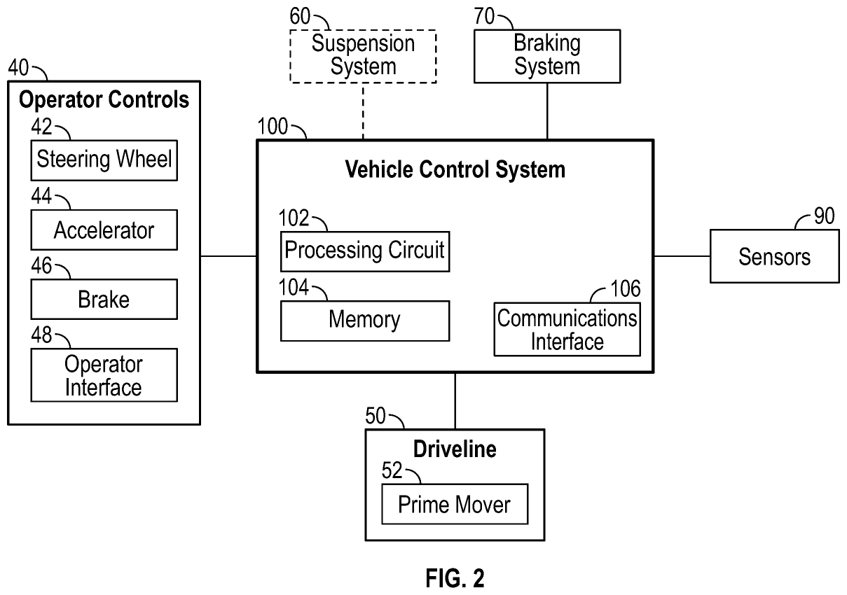

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components. According to an exemplary embodiment, the vehicle 10 is an off-road machine or vehicle.

In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

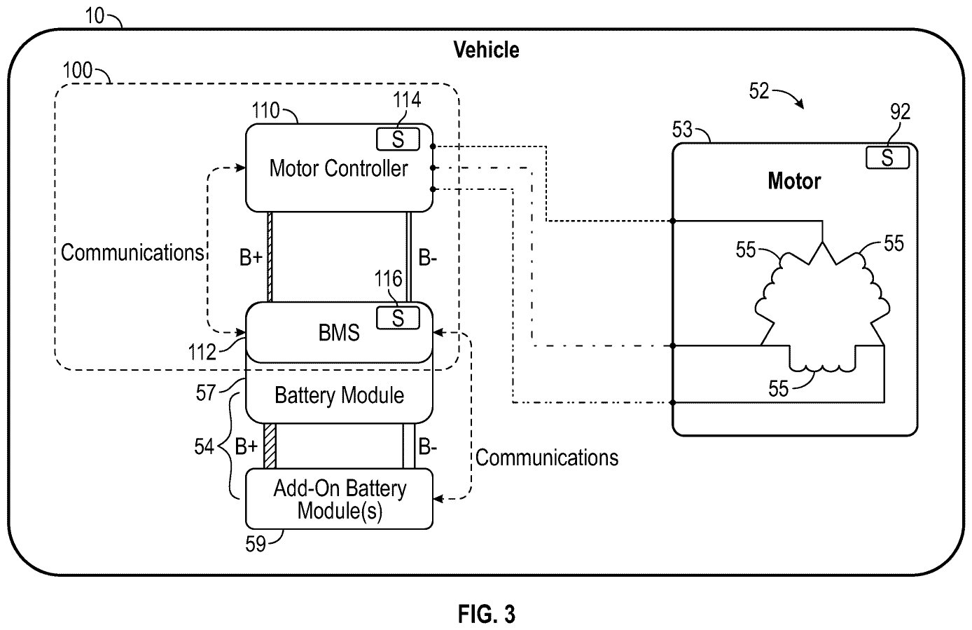

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

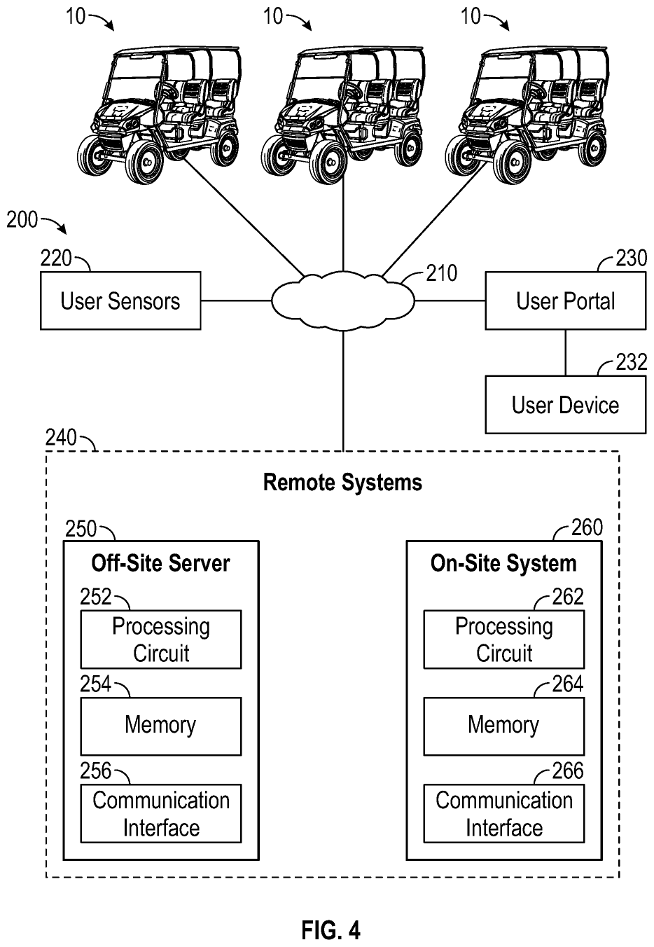

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Electronically Controlled Friction Brake

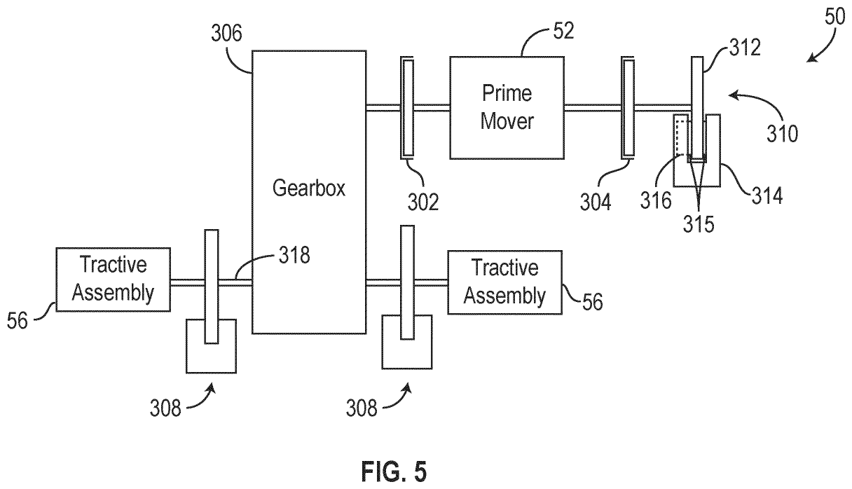

Referring to FIGS. 5-7, the driveline 50 can include an electronically controlled brake 310. The electronically controlled brake 310 is coupled with the driveline 50 and is configured to provide braking from a position along the driveline 50 other than at the rear tractive assemblies 56. In particular, the electronically controlled brake 310 can be configured to provide braking for the tractive assemblies 56 by providing a braking force to a shaft of a gearbox 306. Advantageously, the driveline 50 equipped with the electronically controlled brake 310 provides driveline braking that is used to decelerate the vehicle 10 without requiring friction hydraulic brakes locally disposed at each tractive element.

As shown in FIG. 5, the driveline 50 includes the prime mover 52, a first clutch 302, a second clutch 304, the electronically controlled brake 310, a gearbox 306 (e.g., a differential, a transaxle, etc.), an axle 318, and the rear tractive assemblies 56. The prime mover 52 is configured to drive the rear tractive assemblies 56 through the gearbox 306. The driveline 50 can also optionally include hydraulically controlled friction brakes 308 (e.g., rotors and pads) at the rear tractive assemblies 56. The driveline prime mover 52 is coupled between the first clutch 302 and the second clutch 304. The first clutch 302 and the second clutch 304 can be configured to transition between an engaged state or position and a disengaged state or position. The prime mover 52 can be selectively engaged or disengaged from the gearbox 306 via the first clutch 302. The electronically controlled friction brake 310 can be selectable engaged or disengaged from the prime mover 52 via the second clutch 304.

The electronically controlled friction brake 310 includes a rotor 312, a caliper 314, and brake pads 315. The brake pads 315 can be controlled by an electric actuator 316 to engage the rotor 312 to provide friction braking to the rotor 312. The rotor 312 is coupled with the prime mover 52 via the second clutch 304. The electronically controlled friction brake 310 can be operated to exert the friction braking to the rotor 312 to decelerate the vehicle 10 during a stopping operation. In some embodiments, the electronically controlled friction brake 310 can be operated to engage the rotor 312 to function as a park brake. The electronically controlled friction brake 310 can be used in addition to or in place of regenerative braking via the prime mover 52, or in addition to or in place of braking at the tractive assemblies 56 via the friction brakes 308. In other embodiments, the electronically controlled friction brake 310 is a hydraulic friction brake.

For a vehicle that is configured to implement regenerative braking via the prime mover 52, burn-off circuits for excess electrical energy are provided. The burn-off circuits can be used to facilitate providing continued braking (e.g., a source for the energy generated by using the prime mover 52 to brake) when battery capacity is full and the energy generated through regenerative braking cannot be charged into the batteries (e.g., the battery is incapable of being charged further due to already being fully charged). Advantageously, the electronically controlled friction brake 310 can provide braking force even when regenerative braking is no longer feasible via the prime mover 52 due to the batteries being full. The electronically controlled friction brake 310 can remove the need for the burn-off circuits thereby providing improved cost and reliability of the driveline 50. The electronically controlled friction brake 310 can also be provided to provide braking in the case of failure of the prime mover 52. For example, if the prime mover 52 fails due to electrical or mechanical fault, the electronically controlled friction brake 310 can still provide braking for the vehicle 10.

In some embodiments, the electronically controlled friction brake 310 includes springs that are configured to bias the pads 315 into an engaged state or position. The actuator 316 controls the amount of braking force by driving the pads 315 out of engagement (e.g., into disengagement by reducing the force or pressure provided by the pads 315) with the rotor 312. In this implementation of the electronically controlled friction brake 310, the electronically controlled brake 310 defaults to an engaged state in a case of electrical failure.

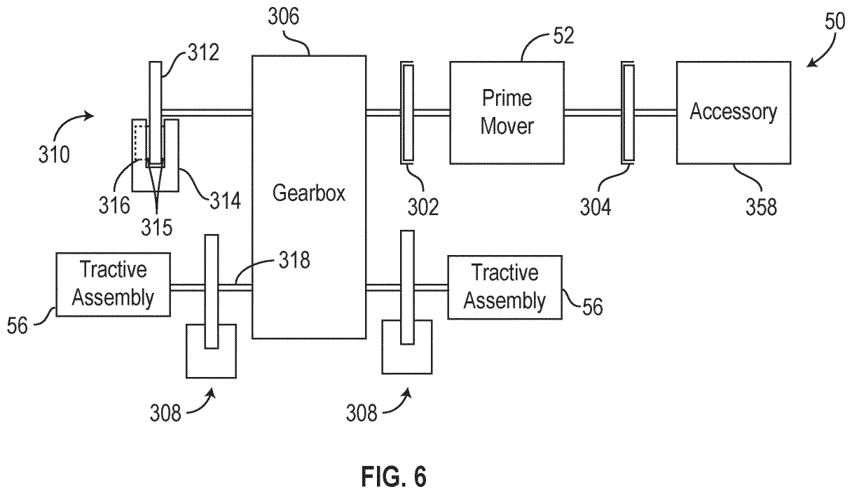

Referring to FIG. 6, another embodiment of the driveline 50 with the electronically controlled friction brake 310 coupled with the gearbox 306 is shown. The electronically controlled friction brake 310 is coupled with an input of the gearbox 306 on an opposite side of the gearbox 306 as the input from the prime mover 52. The prime mover 52 is configured to drive an accessory 358 through the second clutch 304. The electronically controlled friction brake 310 is configured to be operated responsive to operation of a brake pedal in order to provide braking force as described above with reference to FIG. 5. The braking force can be supplemental to regenerative braking provided by the prime mover 52. In some embodiments, the electronically controlled friction brake 310 can also function as a parking brake. The electronically controlled friction brake 310 can be dynamically adjusted in order to provide adjustable amounts of braking force provided to the rotor 312 and transferred through the gearbox 306 to the tractive assemblies 56. In some embodiments, the electronically controlled friction brake 310 is dynamically adjustable in order to provide adjustable braking force responsive to depression of the brake pedal, while also providing maximum braking force once power is removed (e.g., parking brake functionality). The parking brake functionality can be enabled by using a spring that biases the electronically controlled brake 310 (e.g., the caliper 314) into a fully engaged state in the case of electrical power failure to the brake 310.

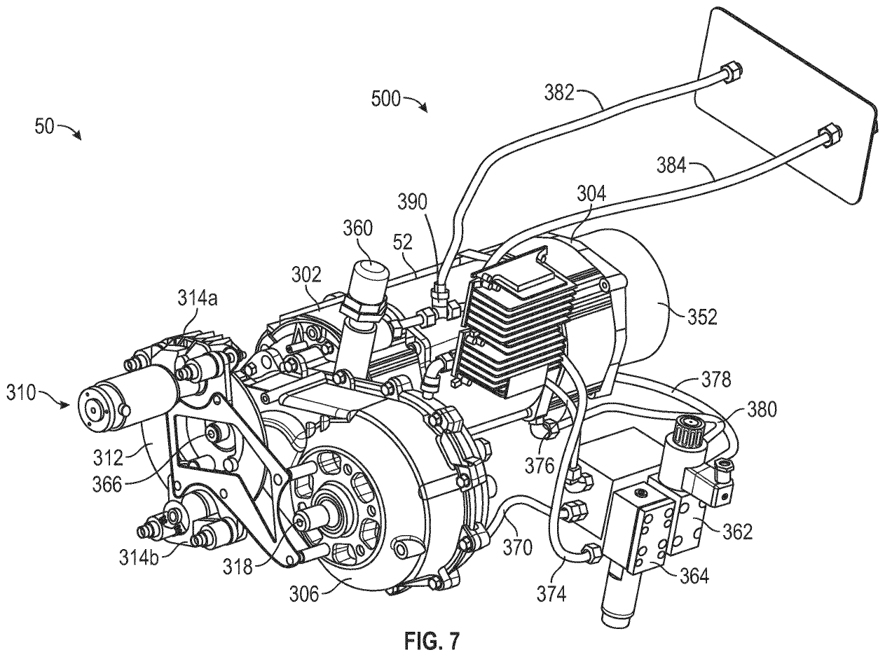

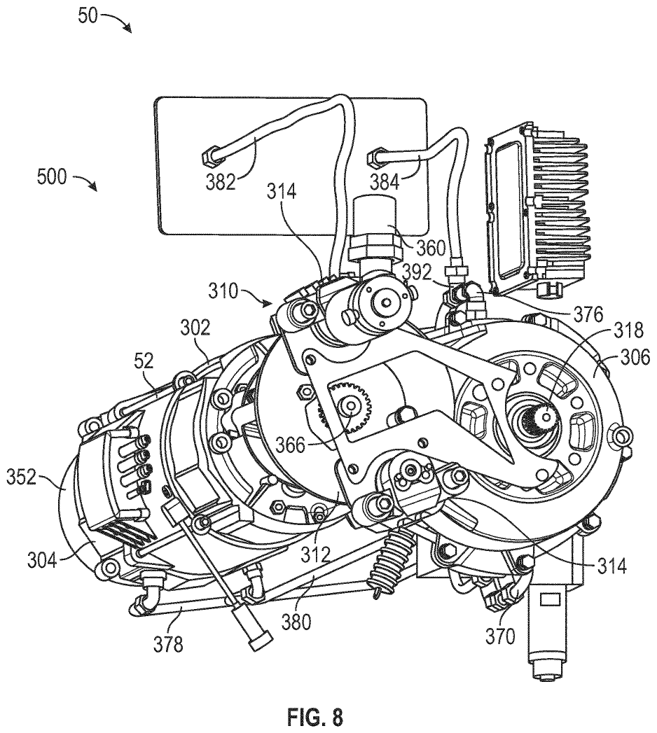

Referring to FIGS. 7 and 8, the electronically controlled brake 310 is shown provided on the driveline 50. The brake 310 is provided on a side of the gearbox 306 opposite the prime mover 52. The brake 310 can be coupled with a through-axle 366 (e.g., a through axle) that protrudes through the housing of the gearbox 306 on both sides. On a first side of the gearbox 306, the prime mover 52 is coupled with the through-axle 366 through the first clutch 302. The rotor 312 of the brake 310 is coupled with the through-axle 366 on a second side of the gearbox 306 opposite the prime mover 52. The brake 310 can include a parking brake, shown as parking brake caliper 314a, and a service brake, shown as service brake caliper 314b (e.g., a variable brake). The parking brake caliper 314a is configured to transition between a disengaged state and an engaged state. The parking brake caliper 314a can be bias to transition into the engaged state (e.g., by a spring) when electrical energy is lost (e.g., in response to losing power). In some embodiments, the parking brake caliper 314a includes an electric actuator configured to control the parking brake caliper 314a out of engagement with the rotor 312.

Referring again to FIGS. 5-8, the electronically controlled brake 310 can be provided to function as a magnetic brake, or a biased closed and controlled open brake, or a combination of both. The electronically controlled brake 310 can be dynamically adjusted in order to provide variable braking by operating an electric actuator, or can function as a parking brake, or both. Advantageously, the electronically controlled brake 310 provides an additional point of braking to supplement regenerative braking that can remove the need for a burn-off circuit.

### Braking With Hydraulic Pump

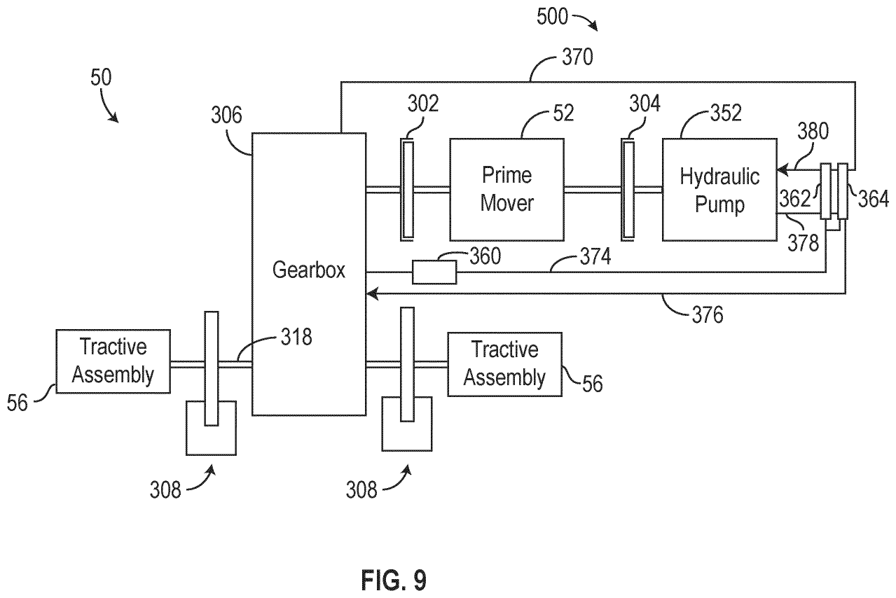

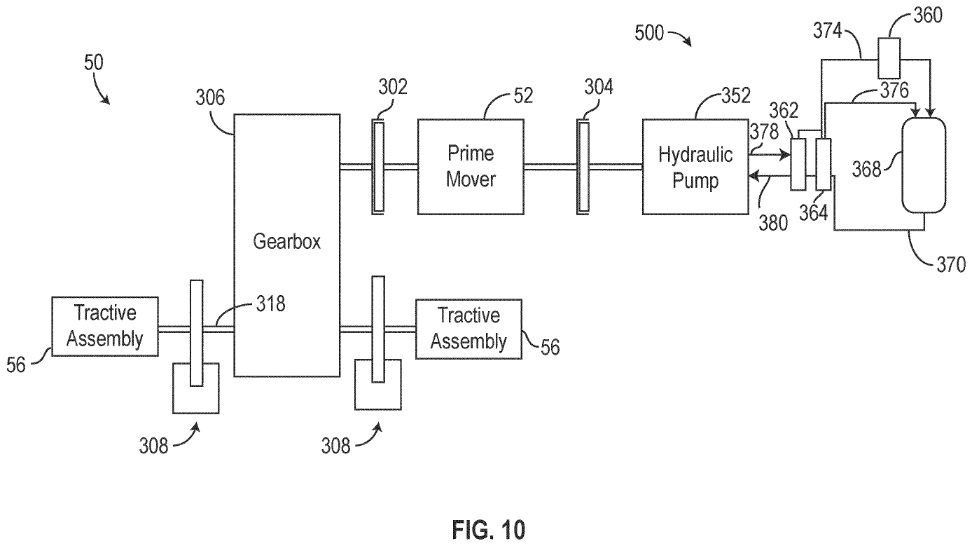

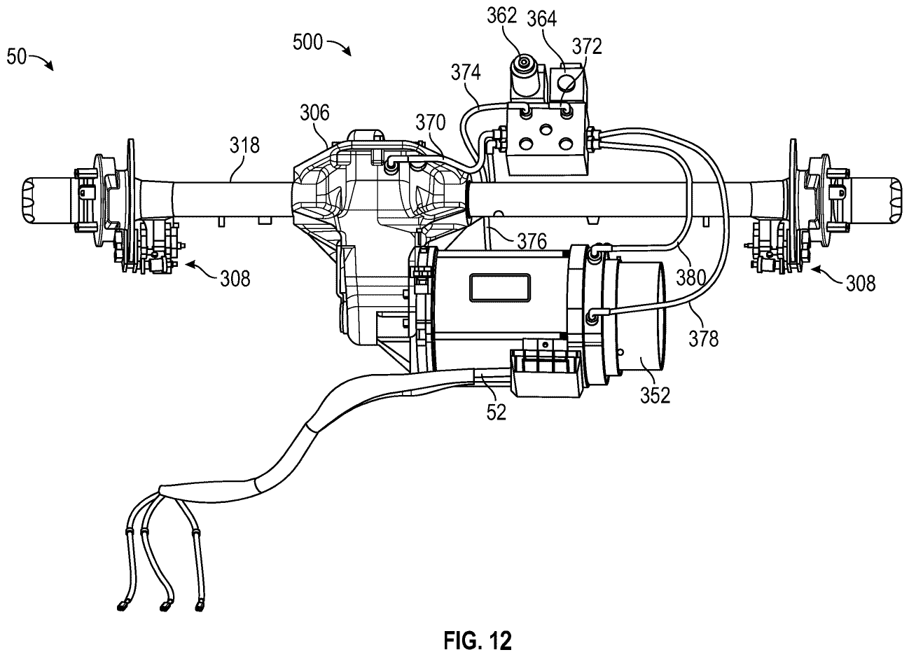

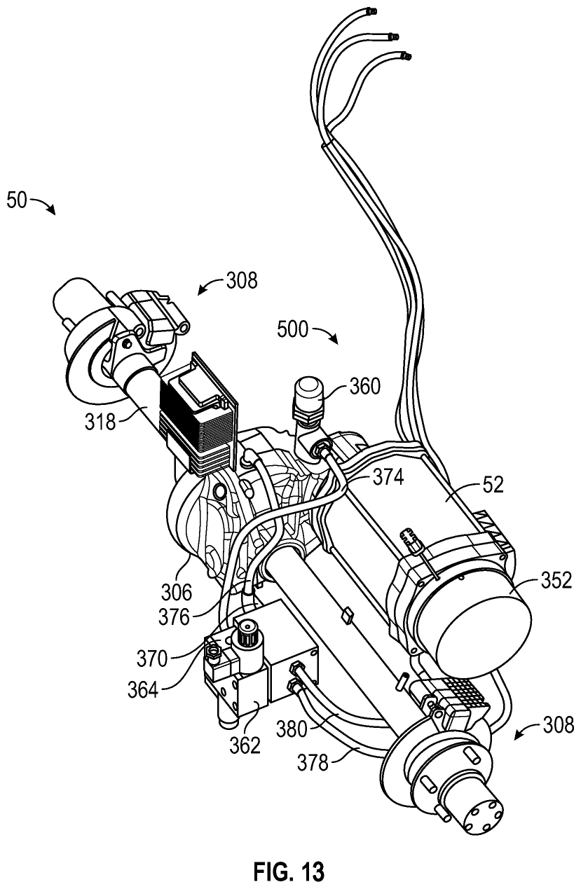

Referring to FIGS. 9-13, the driveline 50 can include a hydraulic system 500 including a hydraulic pump 352 coupled with the driveline 50. The hydraulic pump 352 can be operated to provide braking for the driveline 50. The hydraulic pump 352 can coupled with the prime mover 52 through the second clutch 304 (e.g., a power take off). The hydraulic pump 352 is configured to pressurize a fluid (e.g., a hydraulic fluid, oil, etc.) and discharge the fluid through a first discharge line 378 (e.g., a pipe, a tubular member, a hose, a conduit, etc.) of the hydraulic system 500. The hydraulic pump 352 is configured to circulate the fluid through a circuit defined by the first discharge line 378, a first high pressure line 376, a second high pressure line 374, a return line 370, and a suction line 380 of the hydraulic system 500. The hydraulic pump 352 is configured to discharge fluid through a line switching valve 362 and an electronic pressure control valve 364 of the hydraulic system. The hydraulic pump 352 can be driven by the prime mover 52, or back driven by the rotation of the rear tractive assemblies 56 through the gearbox 306, the first clutch 302, the prime mover 52, and the second clutch 304. The hydraulic pump 352 is configured to circulate fluid through the hydraulic circuit and the line switching valve 362 and the electronic pressure control valve 364.

The line switching valve 362 is configured to selectively transition between a first position and a second position to reverse the suction and pressure or discharge side of the pump 352 as the vehicle 10 transitions between forwards and rearwards direction of travel. As the vehicle 10 travels in the forwards direction of travel, the tractive elements and the gearbox 306 are driven to rotate by the prime mover 52 in a first direction. The prime mover 52 also drives the hydraulic pump 352 in the first direction. As the vehicle 10 travels in the rearwards direction of travel (e.g., the vehicle 10 travels in a reverse direction or a reverse gear), the prime mover 52 drives the gearbox 306 and tractive elements, and likewise the pump 352 in a second direction. Accordingly, the direction of the hydraulic pump 352 changes and therefore the line switching valve 362 is configured to be adjusted to change the discharge and suction side of the hydraulic pump 352 such that the hydraulic pump 352 draws from a sump or lower point of the gearbox 306 or reservoir. The pump 352 is configured to draw fluid from the reservoir (e.g., the housing of the gearbox 306, a tank separate from the gearbox 306, etc.) to the line switching valve 362 through the return line 370. The pump 352 is fluidly coupled with the line switching valve 362 through the suction line 380 and the discharge line 378. The line switching valve 362 is configured to operate such that the discharge line 378 or the suction line 380, depending on which is functioning as the discharge line due to the direction of driving of the pump 352, discharge fluid to a high pressure or return side of the tank (e.g., the housing of the gearbox 306) via the first high pressure line 374. In some embodiments, the position of the line switching valve 362 is controlled by a controller based on a currently selected gear of the vehicle 10 or based on a current direction of travel of the vehicle 10.

Before fluid is returned or discharged by the pump 352 to the return side of the tank (e.g., the return side of the gearbox 306 via first high pressure line 376, or to the return side of a separate tank 368 via first high pressure line 376), the fluid is passed through the electronic pressure control valve 364. The electronic pressure control valve 364 is configured to default to a normally closed position such that the pump 352 deadheads and fluid pressure limits rotation of the pump 352. The electronic pressure control valve 364 can be operated to variably adjust the pressure of fluid that is allowed through the electronic pressure control valve 364. In this way, the operation of the electronic pressure control valve 364 can control the driving of the pump 352. As the electronic pressure control valve 364 closes, due to operation of a brake pedal or other control input, the hydraulic pump 352 experiences higher back-pressure and approaches a dead-head or locking state in which the electronic pressure control valve 364 is fully closed. The operation of the electronic pressure control valve 364 therefore provides a braking force or back-pressure onto the hydraulic pump 352 which is transferred to the tractive elements of the vehicle 10 through the prime mover 52, the gearbox 306, and the axle 318. The electronic pressure control valve 364 is configured to be operated in order to regulate an amount of braking torque provided to the tractive elements.

As shown in FIGS. 9, 10, and 12, the second high pressure line 374 is fluidly coupled with both the electronic pressure control valve 364 and the line switching valve 362 via connector 372 (e.g., a tee connector) of the hydraulic system 500. The second high pressure line 374 is configured to return fluid to the gearbox 306 or the separate tank 368 of the hydraulic system 500 through the pressure regulator 360. The pressure regulator 360 sets a limit on a maximum pressure that the hydraulic pump 352 experiences. The pressure regulator 360 can be adjustable to provide different limits on the maximum pressure. The pressure regulator 360 is configured to operate such that, when the electronic pressure control valve 364 closes fully either due to completely pressing the brake pedal (e.g., the brake 46) or due to power loss that causes the electronic pressure control valve 364 to default to the closed position, the pressure regulator 360 causes the vehicle 10 to decelerate instead of locking the tractive elements abruptly. The pressure regulator 360 can set the maximum pressure in order to provide braking torque that results in complete stopping or braking of the vehicle 10. The electronic pressure control valve 364 controls the pressure output by the pump 352 up to the maximum pressure set by the pressure regulator 360. The pressure regulator 360 can be manually adjustable in order to set the maximum pressure.

The hydraulic pump 352, the line switching valve 362, the electronic pressure control valve 364, the return line 370, the suction line 380, the first discharge line 378, the first high pressure line 376, the second high pressure line 374, and the regulator 360 can be provided as the hydraulic system 500 on a golf cart, a recreational vehicle, a luggage cart, etc. Advantageously, the hydraulic pump 352 and the components described herein can be provided in order to facilitate braking without requiring friction brakes at the tractive assemblies 56.

### Power Take-off for Accessory Drive

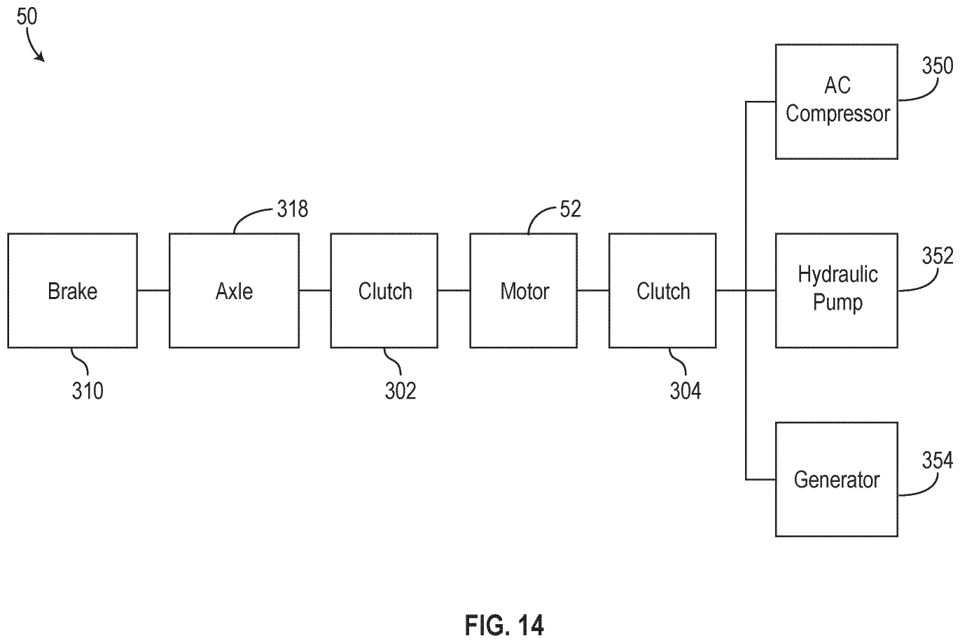

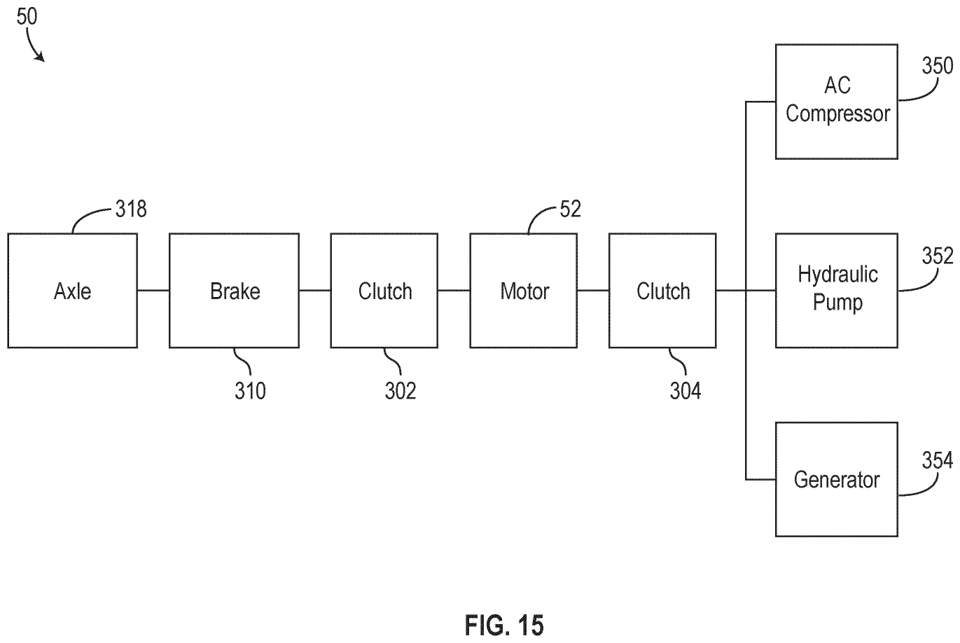

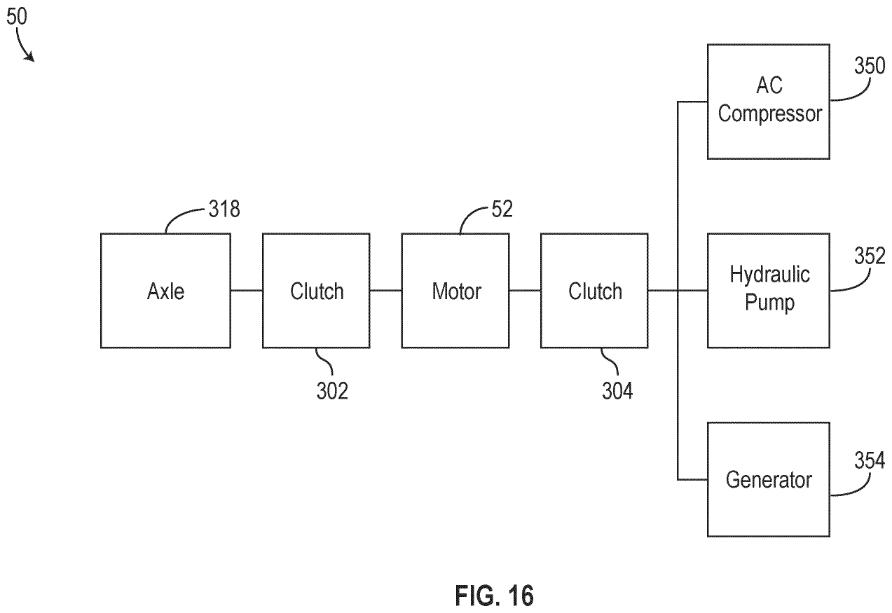

Referring to FIGS. 14-16, the electronically controlled brake 310 (e.g., a parking brake) can be coupled directly with the axle 318 such that the electronically controlled brake 310 cannot be de-coupled from the axle 318. The electronically controlled brake 310 can be coupled between the first clutch 302 and the axle 318 as shown in FIG. 14, or can be coupled directly to the axle 318 as shown in FIG. 15. In some embodiments, the electronically controlled brake 310 is integrated into the first clutch 302. The driveline 50 can further include an air-conditioning compressor 350, the hydraulic pump 352, and/or a generator 354, among other possible accessories. The air-conditioning compressor 350, the hydraulic pump 352, or the generator 354 can be provided as the accessory 358 as described in greater detail above with reference to FIG. 6. The air-conditioning compressor 350, the hydraulic pump 352, or the generator 354 are coupled with the prime mover 52 (e.g., the motor 53) via the second clutch 304 such that the prime mover 52 can be configured to drive the air-conditioning compressor 350, the hydraulic pump 352, or the generator 354 through the second clutch 304 without driving the axle 318 (e.g., by disengaging the first clutch 302). The brake 310 can be coupled with the axle 318 without selectively actuatable clutches such that the brake 310 is configured to provide braking force for the rear tractive assemblies 56.

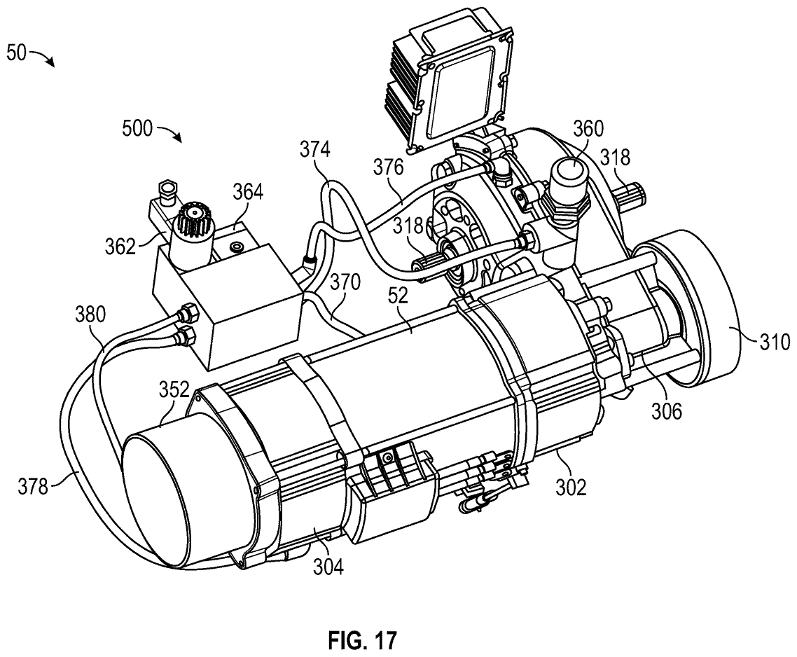

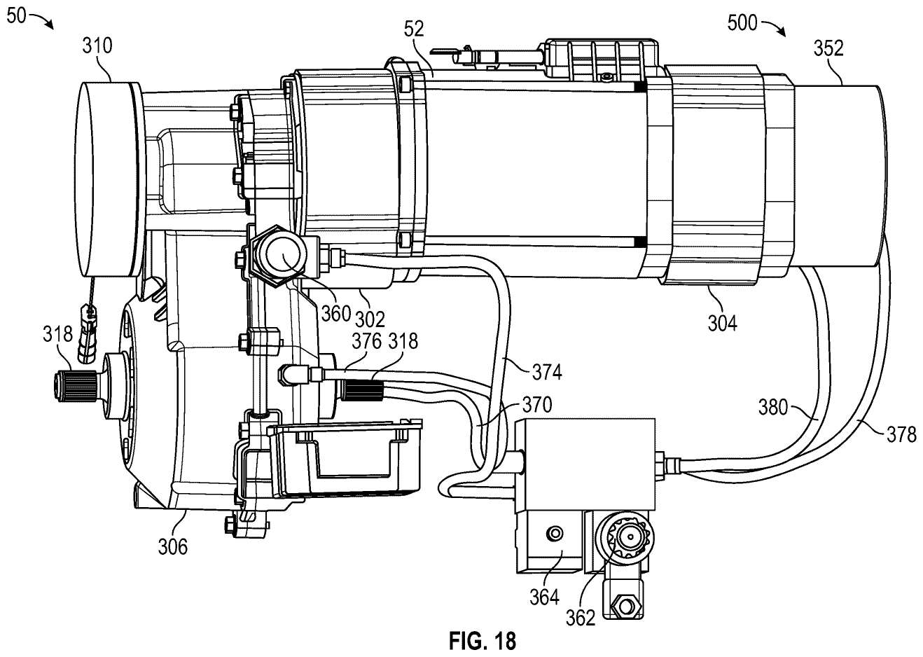

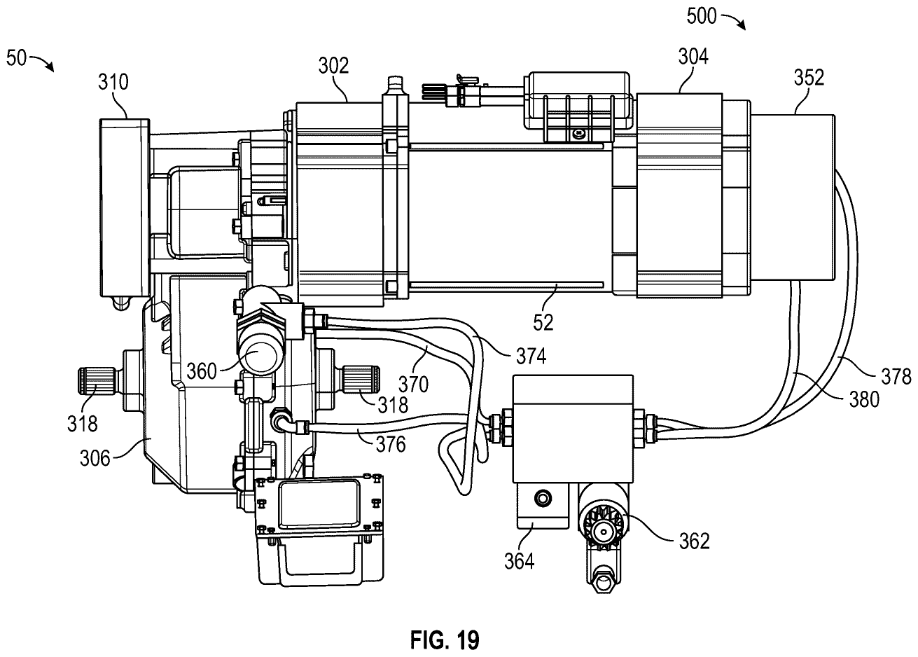

Referring to FIGS. 17-19, the accessory 358 is shown provided as the hydraulic pump 352. The hydraulic pump 352 can be driven by the prime mover 52 through the second clutch 304. The second clutch 304 is configured to transition between an engaged and disengaged state such that the hydraulic pump 352 is configured to engage with the prime mover 52 and be driven by the prime mover 52, or so that the hydraulic pump 352 can be de-coupled from the prime mover 52 such that the prime mover 52 can operated without driving the hydraulic pump 352. It should be understood that any other accessory can be positioned in place of the hydraulic pump 352 including the air-conditioning compressor 350, the generator 354, an alternator, a power steering pump, an accessory drive point, an air compressor for an air suspension, or any other accessory.

The prime mover 52 is coupled with the gearbox 306 (e.g., the transaxle) through the first clutch 302. In this way, the prime mover 52 is disposed between the first clutch 302 and the second clutch 304 such that the prime mover 52 can be configured to drive the gearbox 306 without driving the hydraulic pump 352, or drive the hydraulic pump 352 without driving the gearbox 306, or drive both the hydraulic pump 352 and the gearbox 306. For example, the first clutch 302 can be transitioned into the engaged state while the second clutch 304 is transitioned into the disengaged state in order to drive the gearbox 306 without driving the accessory (e.g., the hydraulic pump 352). Likewise, the first clutch 302 can be transitioned into the disengaged state while the second clutch 304 is transitioned into the engaged state in order to drive the accessory (e.g., the hydraulic pump 352) without driving the gearbox 306.

The driveline 50 can include the electronically controlled friction brake 310 disposed on a side of the gearbox 306 opposite the first clutch 302, the prime mover 52, the second clutch 304, and the hydraulic pump 352. The electronically controlled friction brake 310 can be coupled with a through-shaft of the gearbox 306 that is parallel with the axle 318 and offset from the axle 318. The through-shaft of the gearbox 306 is coupled with the electronically controlled friction brake 310 on one side and the clutch 302, the prime mover 52, the second clutch 304, and the accessory (e.g., the hydraulic pump 352) on an opposite side. The electronically controlled friction brake 310 can be a parking brake that is configured to transition between two discrete states including an engaged state and a disengaged state. The electronically controlled friction brake 310 can lock the tractive elements of the vehicle 10 and the gearbox 306 in a park state by transitioning into the engaged state. The first clutch 302 can transition into the disengaged state to allow the prime mover 52 to drive the accessory (e.g., the hydraulic pump 352) when the vehicle 10 is in the park state. In some embodiments, the electronically controlled friction brake 310 is provided as a variable brake that can be operated to provide varying braking torque or force. For example, the electronically controlled friction brake 310 can include the caliper 314 or a caliper having a variable electric actuator in order to provide variable braking force to decelerate the vehicle 10. In some embodiments, the electronically controlled friction brake 310 is integrated into or disposed in place of the first clutch 302. In some embodiments, the first clutch 302 is configured to automatically transition into the disengaged state in response to the brake 310 transitioning into a fully engaged or engaged state (e.g., in response to the park brake being activated).

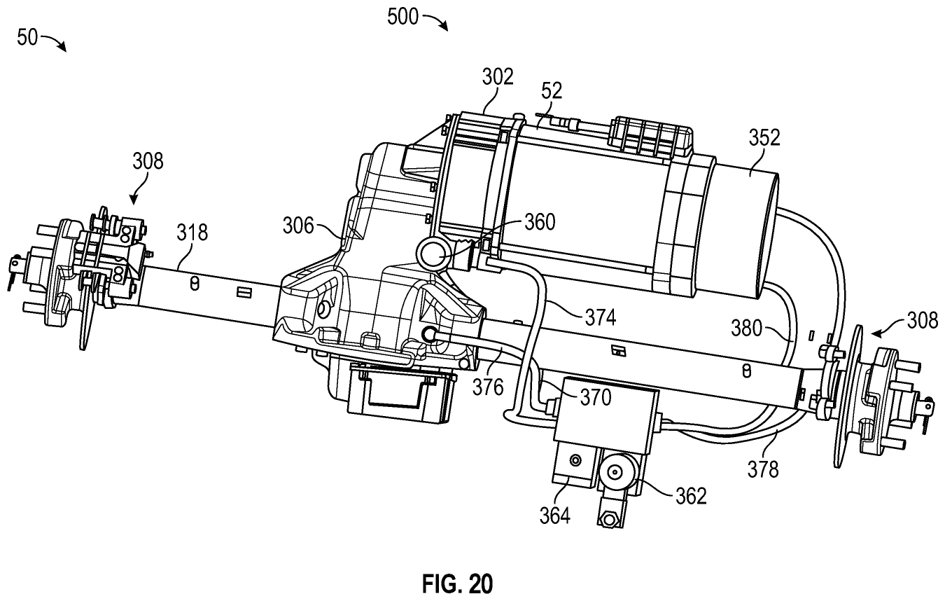

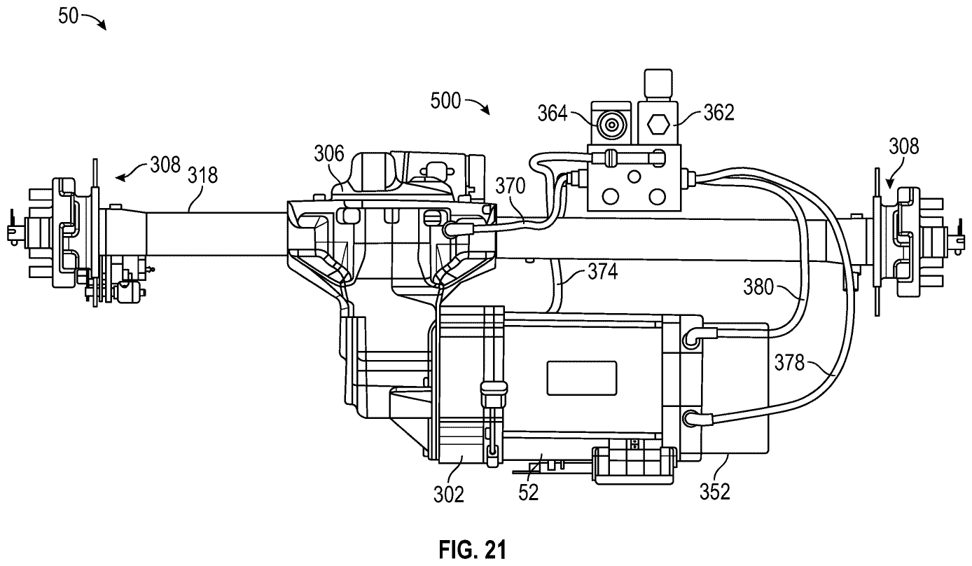

Referring to FIGS. 20 and 21, the driveline 50 can be provided with friction brakes 308 at the tractive assemblies 56. If the driveline 50 is provided with friction brakes 308 that include park brakes as well, the driveline 50 may exclude the electronically controlled friction brake 310 coupled on the side of the gearbox 306 opposite the prime mover 52, or disposed at the position of the first clutch 302. In some embodiments, the driveline 50 includes both the park brake at the friction brakes 308 of the tractive elements, and the electronically controlled friction brake 310.

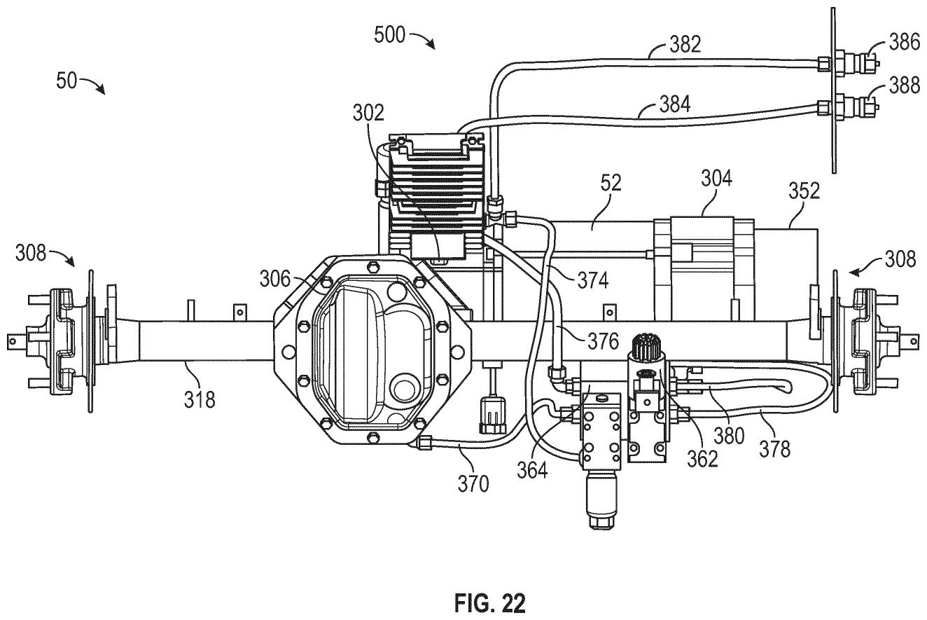

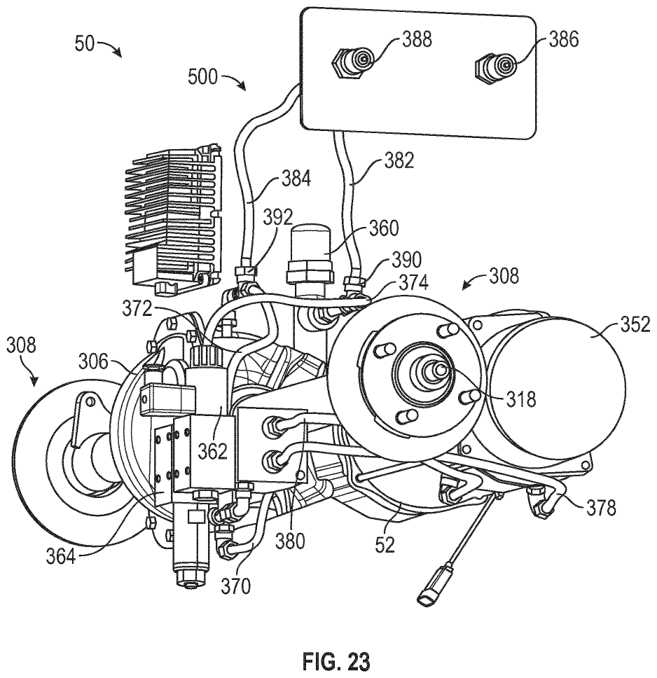

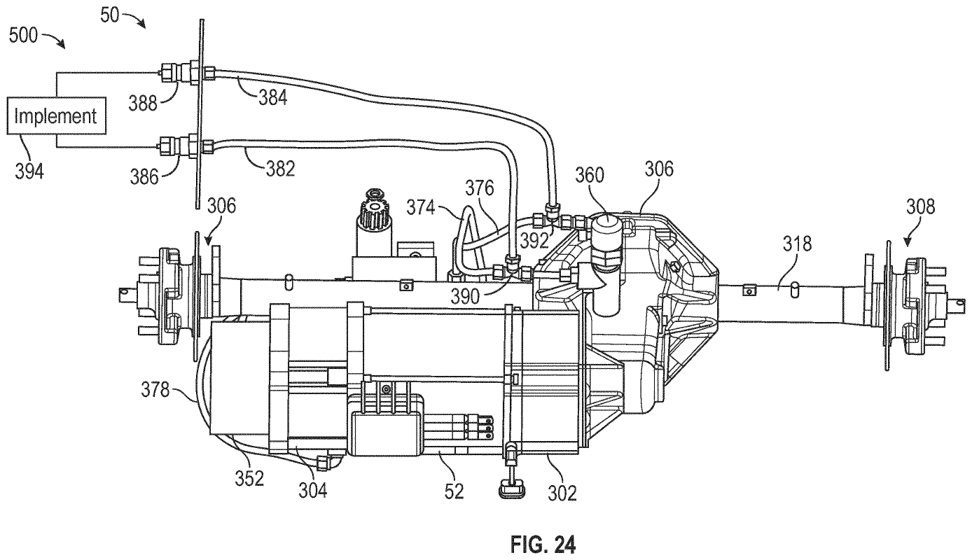

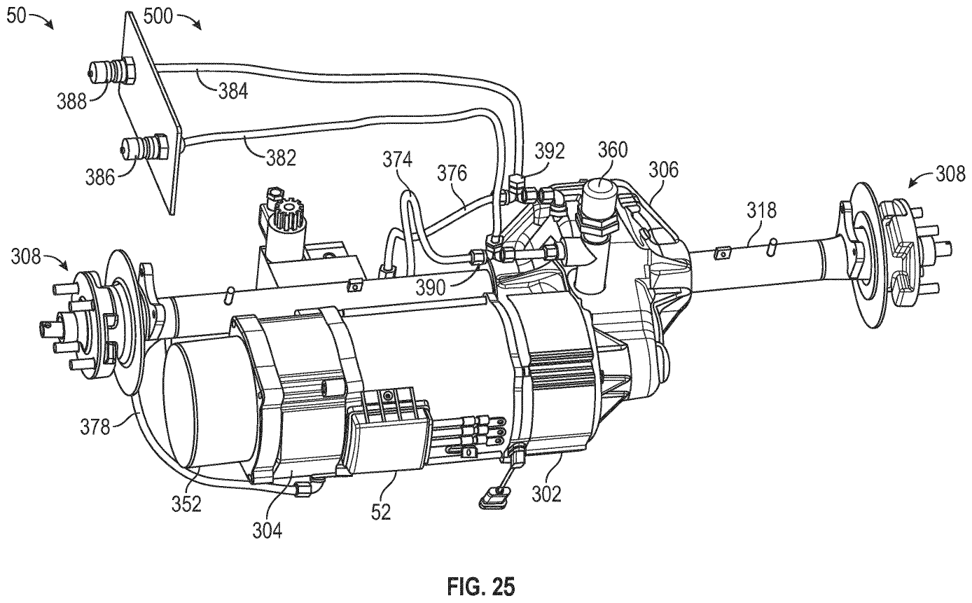

The hydraulic pump 352, if provided as the accessory 358, can be operated as described in greater detail above with reference to FIGS. 9-13 to provide braking for the vehicle 10. The hydraulic pump 352 can additionally or alternatively be configured to be operated as an accessory to provide pressurized fluid to an external source as shown in FIGS. 22-25. As shown in FIGS. 22-25, the hydraulic pump 352 can be configured to provide pressurized fluid to one or more implement connections (e.g., connectors, connection points, ports, fluid interfaces, hydraulic implement interfaces, etc. ,) shown as a pressure port 386 and a return port 388. The hydraulic pump 352 is configured to pressurize fluid to the pressure port 386 and receive return fluid from the return port 388 of the hydraulic system 500. The pressure port 386 and the return port 388 can be disposed on a side of the vehicle 10 such that they are accessible for off-vehicle applications. The pressure port 386 is configured to receive pressurized fluid from the hydraulic pump 352 via a high pressure line 382 that is fluidly coupled with the second high pressure line 374 via a connector 390 (e.g., a tee connector) of the hydraulic system. The return port 388 is configured to return fluid to the hydraulic pump 352 via a low pressure line 384 of the hydraulic system 500 that is fluidly coupled with the first high pressure line 374 or the return line 370. The pressure port 386 and the return port 388 can be quick-connect ports that enable a user to connect external hydraulic devices to the hydraulic pump 352. For example, the pressure port 386 and the return port 388 can be configured to provide hydraulic fluid to a hydraulic implement 394 of the hydraulic system 500. The hydraulic implement 394 can include a hydraulic actuator of a dump bed or container, a skidloader, a fork, a post-hole digger, etc. Advantageously, the hydraulic fluid provided by the hydraulic pump 352 is pre-regulated by the pressure regulator 360. In embodiments in which the hydraulic pump 352 provides pressurized hydraulic fluid for the hydraulic implement 394, the gearbox 306 can be the reservoir for the hydraulic fluid, or a separate reservoir (e.g., separate tank 368) can be provided.

Referring again to FIGS. 22-25, the hydraulic pump 352 can be configured to both provide braking force (e.g., braking torque to decelerate the vehicle 10 as described in greater detail above with reference to FIGS. 9-13) and to simultaneously drive the hydraulic implement 394. For example, the hydraulic pump 352 can be back-driven by the tractive elements during braking events while simultaneously providing pressurized hydraulic fluid to the hydraulic implement 394.

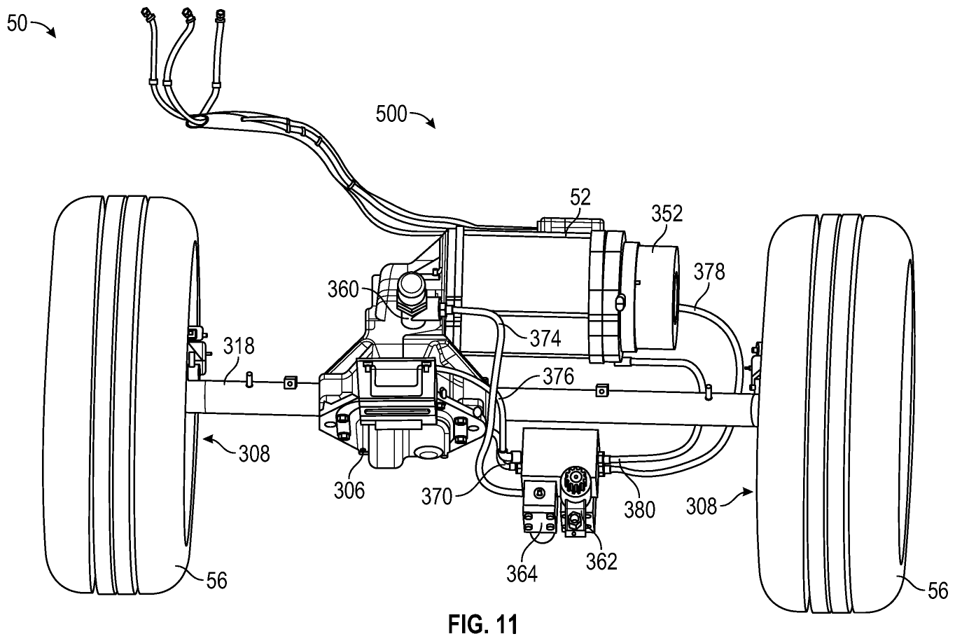

Referring still to FIGS. 22-25, the hydraulic pump 352 can be operated to pressurize hydraulic fluid for the hydraulic implement 394 or any other hydraulic accessory without driving the tractive elements. If the driveline 50 is provided with the first clutch 302 (as shown in FIGS. 22-25), the prime mover 52 and the hydraulic pump 352 can be disengaged from the tractive elements of the rear tractive assemblies 56 by transitioning the first clutch 302 into the disengaged state. If the driveline 50 is not provided with the first clutch 302 (e.g., as shown in FIGS. 11-13), the vehicle 10 can be equipped with a lift actuator or a jack such that the tractive elements of the rear tractive assemblies 56 can be lifted off the ground surface and the hydraulic pump 352 can be operated without causing the vehicle 10 to transport.

Referring again to FIGS. 7 and 8, the embodiment of the driveline 50 with the electronically actuated brake 310 having both the parking brake caliper 314a and the service brake caliper 314b can include the high pressure line 382, the low pressure line 384, the connector 390, the connector 392, the return port 388, and the pressure port 386. The electronically actuated brake 310 can be provided in order to provide braking torque (e.g., both parking brake and variable brake to decelerate the vehicle 10) and the hydraulic pump 352 can be provided on the driveline 50 in order to provide pressurized hydraulic fluid for a hydraulic implement.

### Control System

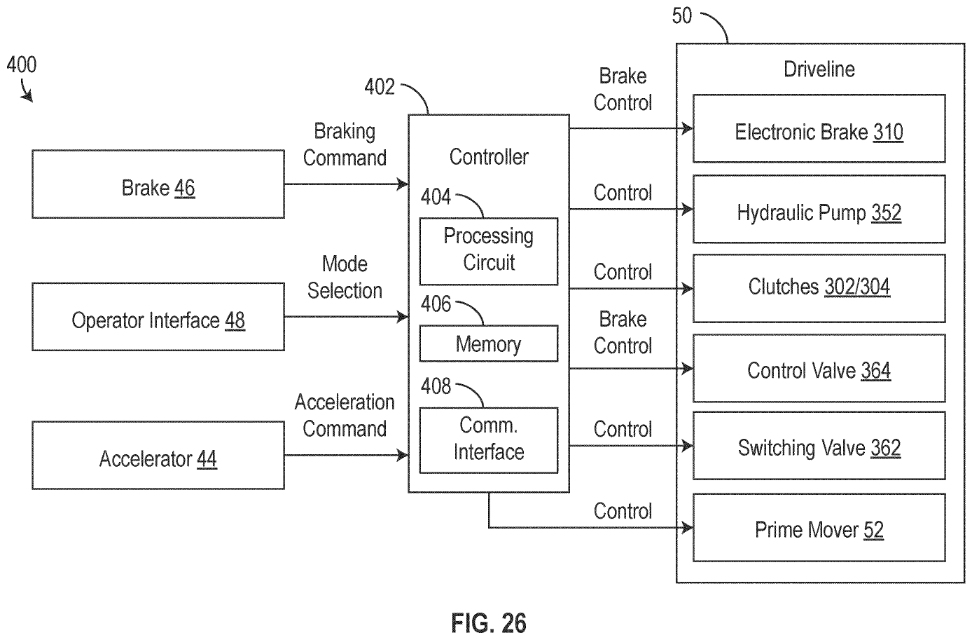

Referring to FIG. 26, a control system 400 for the driveline 50 includes a controller 402, the brake 46, the accelerator 44, and the driveline 50. The controller 402 includes a processing circuit 404, memory 406, and a communications interface 408. The controller 402 can be similar to or the same as the vehicle control system 100 as described in greater detail above with reference to FIG. 2.

The controller 402 is configured to obtain a braking command from the brake 46 (e.g., a degree of depression of a brake pedal). The controller 402 is configured to determine and provide a brake control for either the electronic brake 310 or the control valve 364 based on the braking command obtained from the brake 46. For example, the controller 402 can use a relationship that converts the braking command from the brake 46 to a brake control for the electronic brake 310 that indicates a degree of actuation of an electric actuator of the electronically controlled brake 310. Similarly, if the driveline 50 is configured such that the hydraulic pump 352 is configured to provide braking, the controller 402 can determine, based on a relationship, a position of the electronic pressure control valve 364 based on the braking command in order to achieve desired braking. In some embodiments, the controller 402 is configured to control operation of the control valve 364 and/or the electronic brake 310 in combination with controlling the prime mover 52 to provide regenerative braking.

The controller 402 is configured to transition the switching valve 362 between the first position and the second position based on a direction of travel of the vehicle 10. In some embodiments, the user can provide, via the operator interface 48, a mode selection. The mode selection can include a selected gear (e.g., selected from drive, reverse, neutral, park, etc.). In some embodiments, the controller 402 is configured to transition the line switching valve 362 between the two positions based on the mode selection (e.g., whether drive or reverse is selected) or based on a detected direction of rotation of the tractive elements of the vehicle 10 provided by sensors 90.

The controller 402 is also configured to control operation of the first clutch 302 and/or the second clutch 304 based on the mode selection. For example, the mode selection can be provided from the operator interface 48 and include a selected mode (e.g., driving mode, activation of an accessory or power take-off, etc.). The controller 402 is configured to transition the first clutch 302 and/or the second clutch 304 between the engaged and disengaged states based on the mode selection. For example, if the mode selection provided by the user indicates that the hydraulic pump 352 should be activated (e.g., for driving a hydraulic implement), the controller 402 can operate the second clutch 304 to transition into the engaged state or position. Likewise, if the user desires to activate the hydraulic pump 352 without transporting the vehicle 10, the controller 402 can command the first clutch 302 to transition into the disengaged state or position based on the mode selection.

The controller 402 is also configured to operate the prime mover 52 based on an acceleration command provided by the accelerator 44 (e.g., a degree of depression of the accelerator 44). The controller 402 is configured to adjust power provided to the prime mover 52 (e.g., electric power) based on the acceleration command to transport the vehicle 10.

As utilized herein with respect to numerical ranges, the terms “approximately,” “about,”“substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two

members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf cart comprising:
a frame; and
a driveline coupled with the frame, the driveline including:
a prime mover;
a plurality of tractive assemblies including tractive elements;
an axle coupled with the tractive elements; and
a gearbox configured to transfer torque from the prime mover to the axle and the tractive elements to drive the tractive elements to transport the golf cart; and
a hydraulic system including:
a hydraulic pump fluidly coupled to a fluid reservoir, the hydraulic pump configured to be driven by the prime mover; and
a hydraulic implement interface fluidly coupled with the hydraulic pump and the fluid reservoir, the hydraulic implement interface configured to engage with a hydraulic implement, receive a hydraulic fluid from the hydraulic pump, provide the hydraulic fluid to the hydraulic implement to operate, and return the hydraulic fluid to the fluid reservoir.

2. The golf cart of claim 1, wherein the fluid reservoir is a part of the gearbox.

3. The golf cart of claim 1, wherein the fluid reservoir is separate from the gearbox.

4. The golf cart of claim 1, further comprising a clutch positioned between (a) the prime mover and the gearbox or (b) the prime mover and the hydraulic pump.

5. The golf cart of claim 4, wherein the clutch is positioned between the prime mover and the gearbox to facilitate de-coupling the prime mover from the gearbox such that the prime mover can drive the hydraulic pump without driving the tractive elements.

6. The golf cart of claim 4, wherein the clutch is positioned between the prime mover and the hydraulic pump to facilitate de-coupling the hydraulic pump from the prime mover such that the prime mover can drive the tractive elements to transport the golf cart without driving the hydraulic pump.

7. The golf cart of claim 4, wherein the clutch includes (a) a first clutch positioned between the prime mover and the gearbox and (b) a second clutch positioned between the prime mover and the hydraulic pump.

8. The golf cart of claim 1, wherein the hydraulic system includes a line switching valve configured to be transitioned between a first position and a second position responsive to a change in a direction of travel of the golf cart, wherein in the first position the line switching valve directs fluid from a sump of the fluid reservoir to a first side of the hydraulic pump and in the second position the line switching valve directs fluid from the sump of the fluid reservoir to a second side of the hydraulic pump to account for a change in direction of rotation of the hydraulic pump due to the change in direction of travel of the golf cart.

9. The golf cart of claim 1, wherein the hydraulic system includes a pressure regulator fluidly coupled with an output of the hydraulic pump, the pressure regulator configured to set a maximum pressure allowed to be output by the hydraulic pump.

10. The golf cart of claim 1, wherein the prime mover and the hydraulic pump are configured to be back-driven by the tractive elements through the axle and the gearbox.

11. The golf cart of claim 10, wherein the hydraulic system includes a pressure valve operable to adjust hydraulic back-pressure experienced by the hydraulic pump to provide braking for the tractive elements through the prime mover, the gearbox, and the axle.

12. The golf cart of claim 11, wherein the hydraulic pump is configured to simultaneously provide both braking for the tractive elements and pressurization of the hydraulic fluid to operate the hydraulic implement.

13. The golf cart of claim 1, wherein the driveline includes a brake configured to transition into an engaged state to limit movement of the gearbox, the axle, and the tractive elements.

14. The golf cart of claim 13, wherein the brake is coupled with a shaft on a same side of the gearbox as the prime mover

15. The golf cart of claim 13, wherein the brake is coupled with a shaft on a side of the gearbox opposite the prime mover

16. The golf cart of claim 1, wherein the prime mover is an electric motor operable to provide regenerative braking to charge a battery, the hydraulic pump configured to provide braking in combination with or in place of the regenerative braking while pressurizing the hydraulic fluid and providing the hydraulic fluid to the hydraulic implement, wherein the hydraulic pump is configured to provide braking in addition to the regenerative braking provided by the electric motor such that braking is provided using the hydraulic pump when the battery is fully or substantially fully charged and incapable of or prevented from receiving further charge from regenerative braking of the electric motor.

17. A driveline for a golf cart, the driveline comprising:
a prime mover;
a plurality of tractive assemblies including tractive elements;
an axle coupled with the tractive elements; and
a gearbox configured to transfer torque from the prime mover to the axle and the tractive elements to drive the tractive elements to transport the golf cart; and
a hydraulic system including:
a hydraulic pump fluidly coupled to a fluid reservoir, the pump configured to be driven by the prime mover; and
a hydraulic implement interface fluidly coupled with the hydraulic pump and the fluid reservoir, the hydraulic implement interface configured to engage with a hydraulic implement, receive a hydraulic fluid from the hydraulic pump, provide the hydraulic fluid to the hydraulic implement to operate, and return the hydraulic fluid to the fluid reservoir.

18. The driveline of claim 17, further comprising:
a first clutch positioned between the prime mover and the gearbox to facilitate de-coupling the prime mover from the gearbox such that the prime mover can drive the hydraulic pump without driving the tractive elements;
a second clutch positioned between the prime mover and the hydraulic pump to facilitate de-coupling the hydraulic pump from the prime mover such that the prime mover can drive the tractive elements to transport the golf cart without driving the hydraulic pump; and
a brake configured to transition into an engaged state to limit movement of the gearbox, the axle, and the tractive elements.

19. The driveline of claim 17, wherein the hydraulic system further comprises:
a line switching valve configured to be transitioned between a first position and a second position responsive to a change in a direction of travel of the golf cart, wherein in the first position the line switching valve directs fluid from a sump of the fluid reservoir to a first side of the hydraulic pump and in the second position the line switching valve directs fluid from the sump of the fluid reservoir to a second side of the hydraulic pump to account for a change in direction of rotation of the hydraulic pump due to the change in direction of travel of the golf cart;
a pressure regulator fluidly coupled with an output of the hydraulic pump, the pressure regulator configured to set a maximum pressure allowed to be output by the hydraulic pump; and
a pressure valve operable to adjust hydraulic back-pressure experienced by the hydraulic pump to provide braking for the tractive elements through the prime mover, the gearbox, and the axle, wherein the hydraulic pump is configured to simultaneously provide both braking for the tractive elements and pressurization of the hydraulic fluid to operate the hydraulic implement.

20. A recreational vehicle comprising:
a frame; and
a driveline coupled with the frame, the driveline including:
a prime mover;
a plurality of tractive assemblies including tractive elements;
an axle coupled with the tractive elements;
a gearbox configured to transfer torque from the prime mover to the axle and the tractive elements to drive the tractive elements to transport the recreational vehicle;
a clutch; and
a brake configured to transition into an engaged state to limit movement of the gearbox, the axle, and the tractive elements; and
a hydraulic system including:
a hydraulic pump fluidly coupled to a fluid reservoir, the pump configured to be driven by the prime mover;
a hydraulic implement interface fluidly coupled with the hydraulic pump and the fluid reservoir, the hydraulic implement interface configured to engage with a hydraulic implement, receive a hydraulic fluid from the hydraulic pump, provide the hydraulic fluid to the hydraulic implement to operate, and return the hydraulic fluid to the fluid reservoir; and
a pressure valve operable to adjust hydraulic back-pressure experienced by the hydraulic pump to provide braking for the tractive elements through the prime mover, the gearbox, and the axle, wherein the hydraulic pump is configured to simultaneously provide both braking for the tractive elements and pressurization of the hydraulic fluid to operate the hydraulic implement;
wherein the clutch is positioned either (a) between the prime mover and the gearbox to facilitate de-coupling the prime mover from the gearbox such that the prime mover can drive the hydraulic pump without driving the tractive elements, or (b) between the prime mover and the hydraulic pump to facilitate de-coupling the hydraulic pump from the prime mover such that the prime mover can drive the tractive elements to transport the recreational vehicle without driving the hydraulic pump.
